(19) United States
(12) Patent Application Publication
(10) Pub. No.: US 2019/0222366 A1
(43) Pub. Date: Jul. 18, 2019

(54) METHOD FOR GENERATING HYBRID AUTOMATIC REPEAT REQUEST CODEBOOK, USER EQUIPMENT AND MEDIUM

(71) Applicant: BEIJING SPREADTRUM HI-TECH COMMUNICATIONS TECHNOLOGY CO., LTD., Beijing (CN)

(72) Inventors: Sa ZHANG, Zhangjiang (CN); Huan ZHOU, Zhangjiang (CN)

(21) Appl. No.: 16/183,099

(22) Filed: Nov. 7, 2018

(30) Foreign Application Priority Data
Jan. 12, 2018 (CN) 201810033775.7

(51) Int. Cl. H04L 1/18

(52) U.S. Cl. CPC H04L 1/1893; H04L 1/1812

(57) ABSTRACT

Method for generating a HARQ codebook, a user equipment and a medium are provided. The method includes: receiving PDSCHs each of which includes at least one TB; and to serving cells which are configured with CBG-based HARQ feedback, generating a HARQ codebook corresponding to the PDSCHs using N bits per PDSCH, wherein N is a maximum value of numbers of CBGs corresponding to the PDSCHs. Bit overhead of the CBG-based HARQ feedback may be reduced, and resource utilization may be improved.

### CROSS-REFERENCE TO RELATED APPLICATIONS

The present application claims priority to Chinese patent application No. 201810033775.7, filed on Jan. 12, 2018, and the entire disclosure of which is incorporated herein by reference.

### TECHNICAL FIELD

The present disclosure generally relates to communication field, and more particularly, to a method for generating a hybrid automatic repeat request codebook, a user equipment and a medium.

### BACKGROUND

In a Long Term Evolution (LTE) system and a New Radio (NR) system, a Hybrid Automatic Repeat request (HARQ) mechanism is supported. HARQ is a technology that combines Forward Error Correction (FEC) and Automatic Repeat reQuest (ARQ). FEC helps a receiver to correct errors by adding redundant information, thus reducing times of retransmission. For errors that FEC cannot correct, the receiver requests a sender to retransmit data through the ARQ mechanism. The receiver uses an error-detection code, usually a Cyclic Redundancy Check (CRC) check, to detect whether a received data packet is correctly decoded. If the data packet is correctly decoded, the receiver sends an acknowledgment (ACK) to the sender. After receiving the ACK, the sender will send a new data packet. If the data packet is not correctly decoded, the receiver sends a negative acknowledgment (NACK) to the sender. After receiving the NACK, the sender will retransmit the same data packet.

For the LTE system, the receiver performs HARQ feedback on each Transport Block (TB) using a single bit, that is, feeding back whether each TB is correctly decoded using a single bit. For the NR system, a size of a TB is increased significantly, and the number of code blocks (CBs) in each TB is several times larger compared with the LTE system. Therefore, multiple bits feedback per TB is introduced in NR to increase spectrum efficiency. CBs in one TB are divided into several Code Block Groups (CBGs) each of which includes one or more CBs, and HARQ feedback is performed on each CBG, that is, whether each CBG is correctly decoded is fed back by a single bit. When the CBG is not correctly decoded, the entire CBG will be retransmitted. Therefore, when some CBGs of a TB are incorrectly decoded, only the incorrectly decoded CBGs rather than the entire TB will be retransmitted.

However, in the existing method of performing CBG-based HARQ feedback, HARQ feedback of a TB is performed by using bits corresponding to the maximum value of numbers of CBGs configured for each TB across all the serving cells in a Physical Uplink Control CHannel (PUCCH) group. In case of the number of TBs per Physical Downlink Shared CHannel (PDSCH) is 2, the feedback bits are over dimensioned.

### SUMMARY

By embodiments of the present disclosure, bit overhead of HARQ feedback based on CBG may be reduced, and resource utilization may be improved.

In an embodiment of the present disclosure, a method for generating a HARQ codebook is provided, including: receiving Physical Downlink Shared Channels (PDSCHs) each of which includes at least one TB; and to serving cells which are configured with CBG-based HARQ feedback, generating a HARQ codebook corresponding to the PDSCHs using N bits per PDSCH, wherein N is a maximum value of numbers of CBGs corresponding to the PDSCHs.

Optionally, if the number of the serving cells which are configured with CBG-based HARQ feedback is more than one, and the HARQ codebook is configured as a dynamic HARQ codebook, N is max{Nᵢ}, where i is an identifier of one of the serving cells which are configured with CBG-based HARQ feedback, Nᵢ is the maximum value of numbers of CBGs corresponding to the PDSCHs for the corresponding serving cell i, and max{} represents taking the maximum value.

Optionally, the method may further include: receiving a signaling from a base station, wherein the signaling includes the number of TBs in each of the PDSCHs in the serving cell i; if the number of TBs in each of the PDSCHs in the serving cell i is two, Nᵢ=2×Nᵢ^{TB}; and if the number of TBs in each of the PDSCHs in the serving cell i is one, Nᵢ=Nᵢ^{TB}, where i is an identifier of one of the serving cells which are configured with CBG-based HARQ feedback, and Nᵢ^{TB} is a maximum value of numbers of CBGs corresponding to the TBs for the corresponding serving cell i.

Optionally, if a DCI format corresponding to the PDSCHs is DCI format 1_1, generating the HARQ codebook corresponding to the PDSCHs using N bits per PDSCH includes: if the number of TBs in each of the PDSCHs is two, generating a first HARQ codebook corresponding to CBGs included in a first TB using first N/2 bits; and generating a second HARQ codebook corresponding to CBGs included in a second TB using remaining N/2 bits.

Optionally, generating the first HARQ codebook corresponding to CBGs included in the first TB using the first N/2 bits includes: if M1 is less than N/2, generating the first HARQ codebook corresponding to CBGs included in the first TB using first M1 bits among the first N/2 bits; and setting remaining (N/2−M1) bits to NACK, where M1 is the maximum value of the number of CBGs corresponding to the first TB.

Optionally, generating the second HARQ codebook corresponding to CBGs included in the second TB using the remaining N/2 bits includes: if M2 is less than N/2, generating the second HARQ codebook corresponding to CBGs included in the second TB using first M2 bits among the remaining N/2 bits; and setting remaining (N/2−M2) bits to NACK, where M2 is the maximum value of the number of CBGs corresponding to the second TB.

Optionally, if a DCI format corresponding to the PDSCHs is DCI format 1_1, generating the HARQ codebook corresponding to the PDSCHs using N bits per PDSCH includes: if the number of TBs in each of the PDSCHs is two and M1+M2<N, generating a first HARQ codebook corresponding to CBGs included in a first TB using first M1 bits; generating a second HARQ codebook corresponding to CBGs included in a second TB using M2 bits following the first M1 bits; and setting remaining (N−M1−M2) bits to NACK, where M1 is the maximum value of the number of CBGs corresponding to the first TB, and M2 is the maximum value of the number of CBGs corresponding to the second TB.

Optionally, if a DCI format corresponding to the PDSCHs is DCI format 1_1, generating the HARQ codebook corresponding to the PDSCHs using N bits per PDSCH includes: if the number of TBs in each of the PDSCHs is one and M0<N, generating the HARQ codebook corresponding to CBGs included in the TB using first M0 bits; and setting remaining (N−M0) bits to NACK, where M0 is the maximum value of the number of CBGs corresponding to the TB.

Optionally, if a DCI format corresponding to the PDSCHs is DCI format 1_0, generating the HARQ codebook corresponding to the PDSCHs using N bits per PDSCH includes: generating the HARQ codebook corresponding to the TBs using a first bit; and setting remaining (N−1) bits to NACK.

In an embodiment of the present disclosure, a UE is provided, including: a first receiving circuitry, configured to receive PDSCHs each of which includes at least one TB; and a generating circuitry, configured to: to serving cells which are configured with CBG-based HARQ feedback, generate a HARQ codebook corresponding to the PDSCHs using N bits per PDSCH, where N is a maximum value of numbers of CBGs corresponding to the PDSCHs.

Optionally, if the number of the serving cells which are configured with CBG-based HARQ feedback is more than one, and the HARQ codebook is configured as a dynamic HARQ codebook, N is max{Nᵢ}, where i is an identifier of one of the serving cells which are configured with CBG-based HARQ feedback, Nᵢ is the maximum value of numbers of CBGs corresponding to the PDSCHs for the corresponding serving cell i, and max{} represents taking the maximum value.

Optionally, the UE may further include: a second receiving circuitry configured to receive a signaling from a base station, where the signaling includes the number of TBs in each of the PDSCHs in the serving cell i; if the number of TBs in each of the PDSCHs in the serving cell i is two Nᵢ=2×Nᵢ^{TB}; and if the number of TBs in each of the PDSCHs in the serving cell i is one, Nᵢ=Nᵢ^{TB}, where i is an identifier of one of the serving cells which are configured with CBG-based HARQ feedback, and Nᵢ^{TB} is a maximum value of numbers of CBGs corresponding to the TBs for the corresponding serving cell i.

Optionally, if a DCI format corresponding to the PDSCHs is DCI format 1_1, the generating circuitry is configured to: if the number of TBs in each of the PDSCHs is two, generate a first HARQ codebook corresponding to CBGs included in a first TB using first N/2 bits; and generate a second HARQ codebook corresponding to CBGs included in a second TB using remaining N/2 bits.

Optionally, the generating circuitry is configured to: if M1 is less than N/2, generate the first HARQ codebook corresponding to CBGs included in the first TB using first M1 bits among the first N/2 bits; and set remaining (N/2−M1) bits to NACK, where M1 is the maximum value of the number of CBGs corresponding to the first TB.

Optionally, the generating circuitry is configured to: if M2 is less than N/2, generate the second HARQ codebook corresponding to CBGs included in the second TB using first M2 bits among the remaining N/2 bits; and set remaining (N/2−M2) bits to NACK, where M2 is the maximum value of the number of CBGs corresponding to the second TB.

Optionally, if a DCI format corresponding to the PDSCHs is DCI format 1_1, the generating circuitry is configured to: if the number of TBs in each of the PDSCHs is two and M1+M2<N, generate a first HARQ codebook corresponding to CBGs included in a first TB using first M1 bits; generate a second HARQ codebook corresponding to CBGs included in a second TB using M2 bits following the first M1 bits; and set remaining (N−M1−M2) bits to NACK, where M1 is the maximum value of the number of CBGs corresponding to the first TB, and M2 is the maximum value of the number of CBGs corresponding to the second TB.

Optionally, if a DCI format corresponding to the PDSCHs is DCI format 1_1, the generating circuitry is configured to: if the number of TBs in each of the PDSCHs is one and M0<N, generate the HARQ codebook corresponding to CBGs included in the TB using first M0 bits; and set remaining (N−M0) bits to NACK, where M0 is the maximum value of the number of CBGs corresponding to the TB.

Optionally, if a DCI format corresponding to the PDSCHs is DCI format 1_0, the generating circuitry is configured to: generate the HARQ codebook corresponding to the TBs using a first bit; and set remaining (N−1) bits to NACK.

In an embodiment of the present disclosure, a computer readable storage medium having computer instructions stored therein is provided, where once the computer instructions are executed, any one of the above methods for generating the HARQ codebook is performed.

In an embodiment of the present disclosure, a UE including a memory and a processor is provided, where the memory has computer instructions stored therein, and once the processor executes the computer instructions, any one of the above methods for generating the HARQ codebook is performed.

Embodiments of the present disclosure may provide following advantages. To the serving cells which are configured with CBG-based HARQ feedback, the HARQ codebook corresponding to the PDSCHs is generated using N bits per PDSCH. N is a maximum value of numbers of CBGs corresponding to the PDSCHs rather than a maximum value of numbers of CBGs corresponding to the TBs. Therefore, the configured maximum value of the numbers of CBGs may not be too great to adapt numbers of different TBs. Bit overhead of the CBG-based HARQ feedback may be reduced, and resource utilization may be improved.

### BRIEF DESCRIPTION OF THE DRAWINGS

FIG. 1 schematically illustrates a diagram of a CBG in existing techniques;

FIG. 2 schematically illustrates a flow chart of a method for generating a

HARQ codebook according to an embodiment;

FIG. 3 schematically illustrates a structural diagram of a UE according to an embodiment;

FIG. 4 schematically illustrates a diagram of a HARQ codebook according to an embodiment;

FIG. 5 schematically illustrates a diagram of a HARQ codebook according to an embodiment;

FIG. 6 schematically illustrates a diagram of a HARQ codebook according to an embodiment; and

FIG. 7 schematically illustrates a diagram of a HARQ codebook according to an embodiment; and

FIG. 8 schematically illustrates a diagram of a HARQ codebook according to an embodiment.

### DETAILED DESCRIPTION

For the NR system, a size of a TB is increased significantly. Therefore, multiple bits feedback per TB is introduced in NR to increase spectrum efficiency. CBs in one TB are divided into several CBGs each of which includes one or more CBs, and HARQ feedback is performed on each CBG that is, whether each CBG is correctly decoded is fed back by a single bit. When the CBG is not correctly decoded, the entire CBG will be retransmitted. Therefore, when some CBGs of a TB are incorrectly decoded, only the incorrectly decoded CBGs rather than the entire TB will be retransmitted.

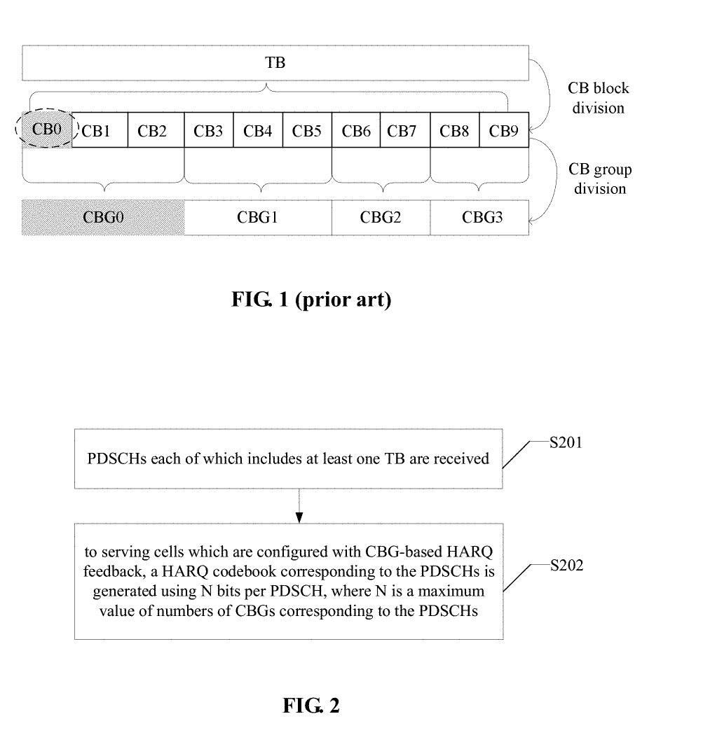

FIG. 1 schematically illustrates a diagram of a CBG in existing techniques.

Referring to FIG. 1, one TB includes ten CBs, which are CB0 to CB9. The ten CBs are divided into 4 CBGs including CBG0 to CGB3, where CBG0 includes CB0 to CB2, CBG1 includes CB3 to CBS, and CBG2 includes CB6 to CB7, and CBG3 includes CB8 to CB9.

If a HARQ codebook is fed back based on CBG when CB0 is not correctly decoded and CBI to CB9 are correctly decoded, a codebook bit corresponding to CBG0 is set to NACK as CB0 belongs to CBG0, and codebook bits corresponding to other CBGs are set to ACK. After receiving the HARQ codebook, the base station only retransmits CB0˜CB2 belonging to CBG0 rather than the entire TB.

In the existing method of performing CBG-based HARQ feedback, HARQ feedback of a TB is performed by using bits corresponding to the maximum value of numbers of CBGs configured for each TB across all the serving cells in a PUCCH group. In case of the number of TBs per PDSCH is 2, the feedback bits are over dimensioned.

In embodiments of the present disclosure, to serving cells which are configured with CBG-based HARQ feedback, a HARQ codebook corresponding to PDSCHs is generated using N bits per PDSCH. N is a maximum value of numbers of CBGs corresponding to PDSCHs rather than a maximum value of numbers of CBGs corresponding to the TBs. Therefore, a configured maximum value of numbers of CBGs may not be too great to adapt numbers of different TBs. Bit overhead of CBG-based HARQ feedback may be reduced, and resource utilization may be improved.

In order to clarify the object, solutions and advantages of embodiments of the present disclosure, embodiments of present disclosure will be described clearly in detail in conjunction with accompanying drawings.

FIG. 2 schematically illustrates a flow chart of a method for generating a HARQ codebook according to an embodiment. Referring to FIG. 2, the method includes S201 and S202.

In S201, PDSCHs each of which includes at least one TB are received.

In some embodiments, the PDSCHs may be received based on schedule information indicated by a Physical Downlink Control Channel (PDCCH).

In some embodiments, the PDCCH may indicate the PDSCHs based on different DCI formats, such as DCI format 1_1 or DCT format 1_0 which can be referred to descriptions of DCI formats in existing protocols and is not described in detail here.

In S202, to serving cells which are configured with CBG-based HARQ feedback, a HARQ codebook corresponding to the PDSCHs is generated using N bits per PDSCH, where N is a maximum value of numbers of CBGs corresponding to the PDSCHs.

In some embodiments, different PDSCHs may be configured with different numbers of CBGs, and a maximum value among the different numbers of CBGs is the maximum value of numbers of CBGs corresponding to the PDSCHs.

In some embodiments, the number of the serving cells which are configured with CBG-based HARQ feedback is one or more.

In some embodiments, if the number of the serving cells which are configured with CBG-based HARQ feedback is more than one, and the HARQ codebook is configured as a dynamic HARQ codebook, N is max{Nᵢ}, where i is an identifier of one of the serving cells which are configured with CBG-based HARQ feedback, Nᵢ is the maximum value of numbers of CBGs corresponding to the PDSCHs for the corresponding serving cell i, and max{} represents taking the maximum value.

In some embodiments, according to 3GPP protocol, if parameter HARQ-ACK-codebook is dynamic, the HARQ codebook is configured as a dynamic HARQ codebook.

In some embodiments, the method may further include: receiving a signaling from a base station, where the signaling includes the number of TBs in each of the PDSCHs in the serving cell i, for example, Number-MCS-HARQ-DL-DCI. If the number of TBs in each of the PDSCHs in the serving cell i is two, Nᵢ=2×Nᵢ^{TB}; and if the number of TBs in each of the PDSCHs in the serving cell i is one, Nᵢ=Nᵢ^{TB}, where i is an identifier of one of the serving cells which are configured with CBG-based HARQ feedback, and Nᵢ^{TB} is a maximum value of numbers of CBGs corresponding to the TBs for the corresponding serving cell i.

In some embodiments, different TBs may be configured with different numbers of CBGs, and a maximum value among the different numbers of CBGs is the maximum value of numbers of CBGs corresponding to the TBs for the corresponding serving cell i.

In some embodiments, if the DCI format corresponding to the PDSCHs is DCI format 1_1, generating the HARQ codebook corresponding to the PDSCHs using N bits per PDSCH may include: if the number of TBs in each of the PDSCHs is two, generating a first HARQ codebook corresponding to CBGs included in the first TB using first N/2 bits; and generating a second HARQ codebook corresponding to CBGs included in the second TB using remaining N/2 bits.

In some embodiments, generating the first HARQ codebook corresponding to CBGs included in the first TB using the first N/2 bits includes: if M1 is less than N/2, generating the first HARQ codebook corresponding to CBGs included in the first TB using first M1 bits among the first N/2 bits; and setting remaining (N/2−M1) bits to NACK, where M1 is the maximum value of the number of CBGs corresponding to the first TB.

In some embodiments, generating the second HARQ codebook corresponding to CBGs included in the second TB using the remaining N/2 bits includes: if M2 is less than N/2, generating the second HARQ codebook corresponding to CBGs included in the second TB using first M2 bits among the remaining N/2 bits; and setting the remaining (N/2−M2) bits to NACK, where M2 is the maximum value of the number of CBGs corresponding to the second TB.

In some embodiments, if the DCI format corresponding to the PDSCHs is DCI format 1_1, generating the HARQ codebook corresponding to the PDSCHs using N bits per PDSCH may include: if the number of TBs in each of the PDSCHs is two and M1+M2<N, generating a first HARQ codebook corresponding to CBGs included in the first TB using first M1 bits; generating a second HARQ codebook corresponding to CBGs included in the second TB using M2 bits following the first M1 bits; and setting remaining (N−M1−M2) bits to NACK, where M1 is the maximum value of the number of CBGs corresponding to the first TB, and M2 is the maximum value of the number of CBGs corresponding to the second TB.

In some embodiments, if the DCI format corresponding to the PDSCHs is DCI format 1_1, generating the HARQ codebook corresponding to the PDSCHs using N bits per PDSCH may include: if the number of TBs in each of the PDSCHs is one and M0<N, generating the HARQ codebook corresponding to CBGs included in the TB using first M0 bits; and setting remaining (N−M0) bits to NACK, where M0 is the maximum value of the number of CBGs corresponding to the TB.

In some embodiments, if the DCI format corresponding to the PDSCHs is DCI format 1_0, generating the HARQ codebook corresponding to the PDSCHs using N bits per PDSCH may include: generating the HARQ codebook corresponding to the TB using a first bit; and setting remaining (N−1) bits to NACK.

In some embodiments, the HARQ codebook indicates for the base station whether the TBs or the CBGs are correctly decoded. The HARQ codebook may be also called as other names with the same meaning, such as HARQ-ACK information or HARQ-ACK feedback, which also falls within the scope of the present disclosure.

In some embodiments, when the UE adopts HARQ-ACK multiplexing, an RRC parameter HARQ-ACK-codebook is “dynamic”, and there are multiple serving cells, i.e., carrier aggregation, to a serving cell C with an RRC parameter CBG-DL=ON (where C is an identifier of the serving cell), the base station configures, for the UE, the maximum value N_{HARQ-ACK,c}^{CBG/TB,max} (i.e., N_{c}^{TB}) of the numbers of CBGs included in the TBs in the serving cell C by using an RRC parameter CBGs-per-TB-DL, where N_{HARQ-ACK,c}^{CBG/PDSCH,max} (i.e., N_{c}) is the maximum value of numbers of CBGs on the PDSCHs for the serving cell C. When an RRC parameter Number-MCS-HARQ-DL-DCI=2, N_{HARQ-ACK,c}^{CBG/PDSCH,max}=2×N_{HARQ-ACK,c}^{CBG/TB,max}; when the RRC parameter Number-MCS-HARQ-DL-DCI=1, N_{HARQ-ACK,c}^{CBG/PDSCH,max}=N_{HARQ-ACK,c}^{CBG/TB,max}, where N_{HARQ-ACK,max}^{CBG/PDSCH,max} (i.e., N) is a maximum value of N_{HARQ-ACK,c}^{CBG/PDSCH,max} of the serving cells with the parameter CBG-DL=ON. When the UE receives one PDSCH scheduled by a PDCCH or a Semi-Persistent Scheduling (SPS) deactivation indicated by a PDCCH, the UE uses N_{HARQ-ACK,max}^{CBG/PDSCH,max} HARQ-ACK bits to feed back a CBG-level HARQ-ACK. The total codebook includes two sub-codebooks, where the first sub-codebook is a HARQ-ACK feedback of the cell with the RRC parameter CBG-DL=OFF, the second sub-codebook is a HARQ-ACK feedback of the cell with the RRC parameter CBG-DL=ON, and the second sub-codebook is located after the first sub-codebook.

For a cell with CBG-DL=ON,

when the UE receives a PDSCH scheduled in the DCI format 1_1 and the RRC parameter Number-MCS-HARQ-DL-DCI=2, first N_{HARQ-ACK,max}^{CBG/PDSCH,max}/2 bits may be used to indicate HARQ-ACK information of CBGs included in a first TB; if N_{HARQ-ACK,c}^{CBG/TB0} of CBGs included in the first TB is less than N_{HARQ-ACK,max}^{CBG/PDSCH,max}/2, first N_{HARQ-ACK,c}^{CBG/TB0} bits feed back HARQ-ACK information of CBGs included in TB0, and remaining (N_{HARQ-ACK,max}^{CBG/PDSCH,max}/2−N_{HARQ-ACK,c}^{CBG/TB0}) bits are set to NACK; last N_{HARQ-ACK,max}^{CBG/PDSCH,max}/2 bits may be used to indicate HARQ-ACK information of CBGs included in a second TB; if N_{HARQ-ACK,c}^{CBG/TB1} of CBGs included in the second TB is less than N_{HARQ-ACK,max}^{CBG/PDSCH,max}/2, first N_{HARQ-ACK,c}^{CBG/TB0} bits feed back HARQ-ACK information of CBGs included in TB1, and remaining (N_{HARQ-ACK,max}^{CBG/PDSCH,max}/2−N_{HARQ-ACK,c}^{CBG/TB1}) bits are set to NACK;

when the UE receives a PDSCH scheduled in the DCI format 1_1 and the RRC parameter Number-MCS-HARQ-DL-DCI=2, first N_{HARQ-ACK,c}^{CBG/TB} bits may be used to indicate HARQ-ACK information of CBGs included in the first TB, N_{HARQ-ACK,c}^{CBG/TB} bits following the first N_{HARQ-ACK,c}^{CBG/TB} bits may be used to indicate HARQ-ACK information of CBGs included in the second TB, and if 2N_{HARQ-ACK,c}^{CBG/TB}<N_{HARQ-ACK,max}^{CBG/PDSCH,max}, remaining (N_{HARQ-ACK,max}^{CBG/TB1}) bits are used to feed back NACK;

when the UE receives a PDSCH scheduled in DCI format 1_1 and the RRC parameter Number-MCS-HARQ-DL-DCI=1, first N_{HARQ-ACK,max}^{CBG/PDSCH,max} bits may be used to indicate HARQ-ACK information of CBGs included in the first TB, N_{HARQ-ACK,c}^{CBG/TB} bits following the first N_{HARQ-ACK,max}^{CBG/PDSCH,max} bits may be used to indicate HARQ-ACK information of CBGs included in the second TB, and if 2N_{HARQ-ACK,c}^{CBG/TB}<N_{HARQ-ACK,max}^{CBG/PDSCH,max}, remaining (N_{HARQ-ACK,max}^{CBG/PDSCH,max}−2N_{HARQ-ACK,c}^{CBG/TB1}) bits are used to feed back NACK;

when the UE receives a PDSCH scheduled in the DCI format 1_1 and the RRC parameter Number-MCS-HARQ-DL-DCI=1, N_{HARQ-ACK,max}^{CBG/PDSCH,max} bits may be used to indicate HARQ-ACK information of CBGs included in the TB of the PDSCH. If the number N_{HARQ-ACK,c}^{CBG/TB} of CBGs included in the first TB is less than N_{HARQ-ACK,max}^{CBG/PDSCH,max}, first N_{HARQ-ACK,c}^{CBG/TB0} bits are used to indicate HARQ-ACK information of CBGs included in TB0, and remaining N_{HARQ-ACK,max}^{CBG/PDSCH,max}−N_{HARQ-ACK,c}^{CBG/TB0} bits are set to NACK;

when the UE receives a PDSCH scheduled in DCI format 1_0, a first bit is used to feed back HARQ-ACK information corresponding to the TB scheduled by the PDSCH, and remaining (N_{HARQ-ACK,max}^{CBG/PDSCH,max}−1) bits are set to NACK;

when the UE receives an SPS deactivation indicated in DCI format 1_0, the UE uses a first bit to generate one bit of HARQ-ACK information to be fed back to the PDCCH, where the first bit is ACK and remaining (N_{HARQ-ACK,max}^{CBG/PDSCH,max}−1) bits are NACK; and

if an SPS is activated, N_{SPS} bits are added after a total codebook to correspond to the SPS for transmitting HARQ-ACK.

In some embodiments, when the UE adopts HARQ-ACK multiplexing, an RRC parameter HARQ-ACK-codebook is “dynamic”, and there are multiple serving cells, i.e., carrier aggregation, to a serving cell C with an RRC parameter CBG-DL=ON (where C is an identifier of the serving cell), the base station configures, for the UE, the maximum value N_{HARQ-ACK,c}^{CBG/TB.max} (i.e., N_{c}^{TB}) of the numbers of CBGs included in the TBs in the serving cell C by using an RRC parameter CBGs-per-TB-DL, where N_{HARQ-ACK,c}^{CBG/PDSCH,max} (i.e., N_{c}) is the maximum value of numbers of CBGs on the PDSCHs for the serving cell C. When an RRC parameter Number-MCS-HARQ-DL-DCI=2, N_{HARQ-ACK,c}^{CBG/PDSCH,max}=2×N_{HARQ-ACK,c}^{CBG/TB,max}; when the RRC parameter Number-MCS-HARQ-DL-DCI=1, N_{HARQ-ACK,c}^{CBG/PDSCH,max}=N_{HARQ-ACK,c}^{CBG/TB,max}, where N_{HARQ-ACK,,ax}^{CBG/PDSCH,max} (i.e., N) is a maximum value of N_{HARQ-ACK,c}^{CBG/PDSCH,max} of the serving cells with the parameter CBG-DL=ON. When the UE receives one PDSCH scheduled by a PDCCH or an SPS deactivation indicated by a PDCCH, the UE uses N_{HARQ-ACK,max}^{CBG/PDSCH,max} HARQ-ACK bits to feed back a CBG-level HARQ-ACK. The total codebook includes two sub-codebooks, where the first sub-codebook is a TB-level HARQ-ACK feedback of all cells, the second sub-codebook is a HARQ-ACK feedback of the cell with the RRC parameter CBG-DL=ON, and the second sub-codebook is located after the first sub-codebook.

For a cell with CBG-DL=ON,

when the UE receives a PDSCH scheduled in the DCI format 1_1 and the RRC parameter Number-MCS-HARQ-DL-DCI=2, first N_{HARQ-ACK,max}^{CBG/PDSCH,max}/2 bits may be used to indicate HARQ-ACK information of CBGs included in a first TB; if N_{HARQ-ACK,c}^{CBG/TB0} of CBGs included in the first TB is less than N_{HARQ-ACK,max}^{CBG/PDSCH,max}/2, the first N_{HARQ-ACK,c}^{CBG/TB0} bits feed back HARQ-ACK information of CBGs included in TB0, and remaining (N_{HARQ-ACK,max}^{CBG/PDSCH,max}/2−N_{HARQ-ACK,c}^{CBG/TB0}) bits are set to NACK; las N_{HARQ-ACK,max}^{CBG/PDSCH,max}/2 bits may be used to indicate HARQ-ACK information of CBGs included in a second TB; if N_{HARQ-ACK,c}^{CBG/TB1} of CBGs included in the second TB is less than N_{HARQ-ACK,max}^{CBG/PDSCH,max}/2, first N_{HARQ-ACK,c}^{CBG/TB0} bits feed back HARQ-ACK information of CBGs included in TB1, and remaining (N_{HARQ-ACK,max}^{CBG/PDSCH,max}/2−N_{HARQ-ACK,c}^{CBG/TB1}) bits are set to NACK;

when the UE receives a PDSCH scheduled in the DCI format 1_1 and the RRC parameter Number-MCS-HARQ-DL-DCI=2, first N_{HARQ-ACK,c}^{CBG/TB} bits may be used to indicate HARQ-ACK information of CBGs included in a first TB, N_{HARQ-ACK,c}^{CBG/TB} bits following the first N_{HARQ-ACK,c}^{CBG/TB} bits may be used to indicate HARQ-ACK information of CBGs included in a second TB, and if 2N_{HARQ-ACK,c}^{CBG/TB}<N_{HARQ-ACK,max}^{CBG/PDSCH,max}, remaining (N_{HARQ-ACK,max}^{CBG/PDSCH,max}−2N_{HARQ-ACK,c}^{CBG/TB1}) bits are used to feed back NACK;

when the UE receives a PDSCH scheduled in the DCI format 1_1 and the RRC parameter Number-MCS-HARQ-DL-DCI=1, N_{HARQ-ACK,max}^{CBG/PDSCH,max} bits may be used to indicate HARQ-ACK information of CBGs included in the TB of the PDSCH. If the number N_{HARQ-ACK,c}^{CBG/TB0} of CBGs included in the first TB is less than N_{HARQ-ACK,max}^{CBG/PDSCH,max} first N_{HARQ-ACK,c}^{CBG/TB0} bits are used to indicate HARQ-ACK information of CBGs included in TB0, and remaining N_{HARQ-ACK,max}^{CBG/PDSCH,max}−N_{HARQ-ACK,c}^{CBG/TB0} bits are set to NACK;

when the UE receives a PDSCH scheduled in DCI format 1_0, only TB-level HARQ-ACK is fed back, and CBG-level HARQ-ACK is not fed back;

when the UE receives an SPS deactivation indicated in DCI format 1_0, only TB-level HARQ-ACK is fed back, and CBG-level HARQ-ACK is not fed back; and

if an SPS is activated, N_{SPS} bits are added after a total codebook to correspond to the SPS for transmitting HARQ-ACK.

By above embodiments, to TBs associated with SPS, a generating mode of the HARQ codebook for the TBs associated with SPS is determined based on related parameters, and the HARQ codebook for the TBs associated with SPS is generated based on the determined generating mode. In this way, HARQ feedback in an SPS scenario is realized.

To make those skilled in the art better understand and implement solutions of the present disclosure, embodiments of the present disclosure provide a diagram of a HARQ codebook in FIG. 4.

Referring to FIG. 4, a UE is configured with two serving cells, and an RRC parameter HARQ-ACK-codebook is ‘dynamic’. A primary serving cell has an ID (serial number) of 0 and an RRC parameter CBG-DL=ON. An RRC parameter CBGs-per-TB-DL configures that the maximum number N_{HARQ-ACK}^{CBG/TB,max} of CBGs included in the TB of the primary serving cell is 2, RRC parameter Number-MCS-HARQ-DL-DCI=2, N_{HARQ-ACK,0}^{CBG/TB,max}=2, N_{HARQ-ACK,0}^{CBG/PDSCH,max}=4, and SPS is activated. A secondary serving cell has an ID of 1 and an RRC parameter CBG-DL=ON. An RRC parameter CBGs-per-TB-DL configures that the maximum number N_{HARQ-ACK}^{CBG/TB,max} of CBGs included in the TB of the secondary serving cell is 6, RRC parameter Number-MCS-HARQ-DL-DCI=1, N_{HARQ-ACK,0}^{CBG/TB,max}=6, and N_{HARQ-ACK,0}^{CBG/PDSCH,max}=6.

By above embodiments, when the UE receives one PDSCH scheduled by a PDCCH or an SPS deactivation indicated by a PDCCH, the UE uses N_{HARQ-ACK,max}^{CBG/PDSCH,max} HARQ-ACK bits to feed back a CBG-level HARQ-ACK.

Specifically, in a slot T41, to the serving cell 0, if an SPS deactivation indicated by a PDCCH is received, and HARQ-ACK feedback time (feedback time) K1=4, i.e., four time slots, the generated codebook is 100000; to the serving cell 1, if a PDSCH scheduled with a format of DCI format 1_0 is received and decoded correctly, and feedback time K1=4, the generated codebook is 100000.

In a slot T42, to the serving cell 0, if a PDSCH scheduled with a format of DCI format 1_1 is received and two TBs are decoded correctly, and feedback time K1=2, the generated codebook is 110110.

In a slot T43 corresponding to a HARQ-ACK feedback time point, the total codebook fed back is 100000100000110110.

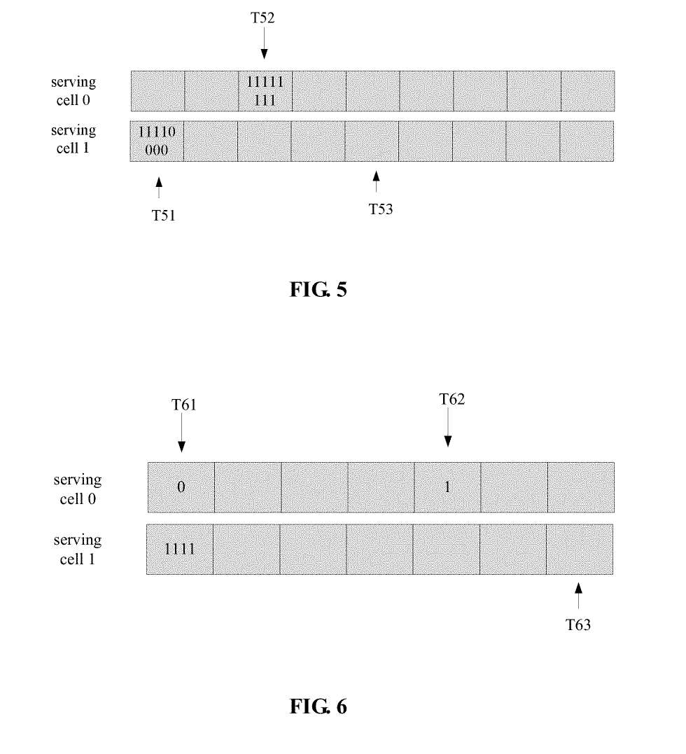

To make those skilled in the art better understand and implement solutions of the present disclosure, embodiments of the present disclosure provide a diagram of a HARQ codebook in FIG. 5.

Referring to FIG. 5, a UE is configured with two serving cells, and an RRC parameter HARQ-ACK-codebook is ‘dynamic’. A primary serving cell has an ID (serial number) of 0 and an RRC parameter CBG-DL=ON. An RRC parameter CBGs-per-TB-DL configures that the maximum number N_{HARQ-ACK}^{CBG/TB,max} of CBGs included in the TB of the primary serving cell is 4, RRC parameter Number-MCS-HARQ-DL-DCI=2, N_{HARQ-ACK,0}^{CBG/TB,max}=4, N_{HARQ-ACK,0}^{CBG/PDSCH,max}=8, and SPS is activated. A secondary serving cell has an ID of 1 and an RRC parameter CBG-DL=ON. An RRC parameter CBGs-per-TB-DL configures that the maximum number N_{HARQ-ACK}^{CBG/TB,max} of CBGs included in the TB of the secondary serving cell is 4, RRC parameter Number-MCS-HARQ-DL-DCI=1, N_{HARQ-ACK,0}^{CBG/TB,max}=4, and N_{HARQ-ACK,0}^{CBG/PDSCH,max}=4.

By above embodiments, when the UE receives one PDSCH scheduled by a PDCCH or an SPS deactivation indicated by a PDCCH, the UE uses N_{HARQ-ACK,max}^{CBG/PDSCH,max}=8 HARQ-ACK bits to feed back a CBG-level HARQ-ACK.

Specifically, in a slot T51, to the serving cell 1, if a PDSCH scheduled with a format of DCI format 1_1 is received and the TB is decoded correctly, and feedback time K1=4, the generated codebook is 11110000.

In a slot T52, to the serving cell 0, if a PDSCH scheduled with a format of DCI format 1_1 is received and two TBs are decoded correctly, and feedback time K1=2, the generated codebook is 11111111.

In a slot T53 corresponding to a HARQ-ACK feedback time point, the total codebook fed back is 1111000011111111.

To make those skilled in the art better understand and implement solutions of the present disclosure, embodiments of the present disclosure provide a diagram of a HARQ codebook in FIG. 6.

Referring to FIG. 6, a UE is configured with two serving cells, and an RRC parameter HARQ-ACK-codebook is ‘dynamic’. A primary serving cell has an ID (serial number) of 0 and an RRC parameter CBG-DL=OFF, and SPS is activated. A secondary serving cell has an ID of 1 and an RRC parameter CBG-DL=ON. An RRC parameter CBGs-per-TB-DL configures that the maximum number N_{HARQ-ACK}^{CBG/TB.max} of CBGs included in the TB of the secondary serving cell is 4, an RRC parameter Number-MCS-HARQ-DL-DCI=1, N_{HARQ-ACK,0}^{CBG/TB,max}=4, and N_{HARQ-ACK,0}^{CBG/PDSCH,max}=4.

By above embodiments, the codebook generated by the UE is as follows.

Specifically, in a slot T61, to the serving cell 0, if a PDSCH of SPS is received and the TB is not decoded correctly, and feedback time K1=6, the generated codebook is 0; to the serving cell 1, if a PDSCH scheduled with a format of DCI format 1_1 is received and the TB is decoded correctly, and feedback time K1=6, the generated codebook is 1111.

In a slot T62, to the serving cell 0, if a PDSCH scheduled with DCI is received and the TB is decoded correctly, and feedback time K1=2, the generated codebook is 1.

In a slot T63 corresponding to a HARQ-ACK feedback time point, the total codebook fed back is 111110, where the sub-codebook 1 is 1, the sub-codebook 2 is 1111, and SPS codebook is 0.

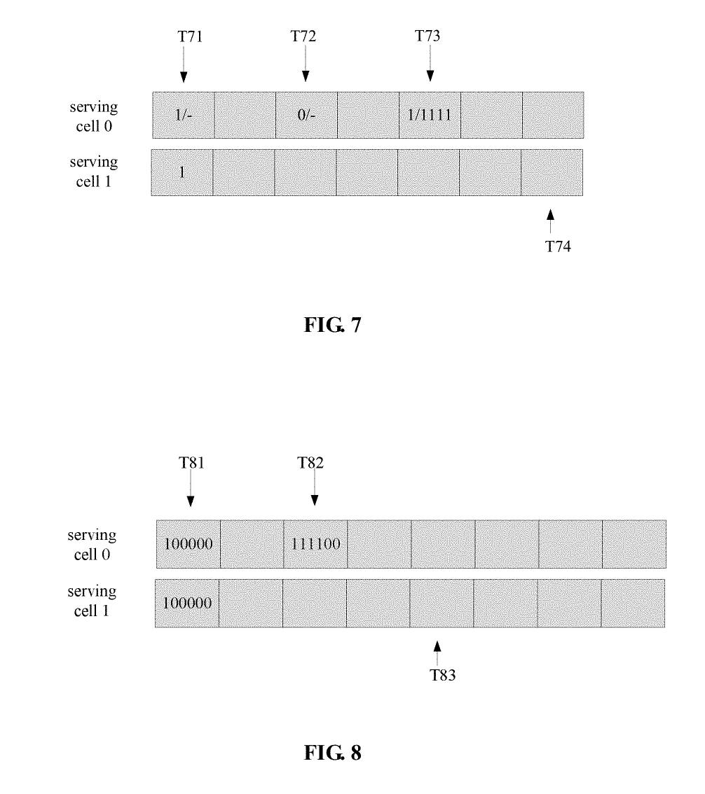

To make those skilled in the art better understand and implement solutions of the present disclosure, embodiments of the present disclosure provide a diagram of a HARQ codebook in FIG. 7.

Referring to FIG. 7, a UE is configured with two serving cells, and an RRC parameter HARQ-ACK-codebook is ‘dynamic’. A primary serving cell has an ID (serial number) of 0 and an RRC parameter CBG-DL=ON. An RRC parameter CBGs-per-TB-DL configures that the maximum number N_{HARQ-ACK}^{CBG/TB,max} of CBGs included in the TB of the primary serving cell is 4, an RRC parameter Number-MCS-HARQ-DL-DCI=1, N_{HARQ-ACK,0}^{CBG/TB,max}=4, N_{HARQ-ACK,0}^{CBG/PDSCH,max}=4, and SPS is activated. A secondary serving cell has an ID of 1 and an RRC parameter CBG-DL=OFF.

By above embodiments, the codebook generated by the UE is as follows.

Specifically, in a slot T71, to the serving cell 0, if an SPS deactivation indicated by a PDCCH is received, and feedback time K1=6, the generated codebook is 1; to the serving cell 1, if a PDSCH scheduled with a format of DCI format 1_1 is received and the TB is decoded correctly, and feedback time K1=6, the generated codebook is 1.

In a slot T72, to the serving cell 0, if a PDSCH scheduled with a format of DCI format 1_0 is received and the TB is not decoded correctly, and feedback time K1=4, the generated codebook is 0.

In a slot T73, to the serving cell 0, if a PDSCH scheduled with a format of DCI format 1_1 is received and the TB is decoded correctly, and feedback time K1=2, the generated codebook is 1/1111.

In a slot T74 corresponding to a HARQ-ACK feedback time point, the total codebook fed back is 11011111, where the sub-codebook 1 is 1101, and the sub-codebook 2 is 1111.

To make those skilled in the art better understand and implement solutions of the present disclosure, embodiments of the present disclosure provide a diagram of a HARQ codebook in FIG. 8.

Referring to FIG. 8, a UE is configured with two serving cells, and an RRC parameter HARQ-ACK-codebook is ‘dynamic’. A primary serving cell has an ID (serial number) of 0 and an RRC parameter CBG-DL=ON. An RRC parameter CBGs-per-TB-DL configures that the maximum number N_{HARQ-ACK}^{CBG/TB,max} of CBGs included in the TB of the primary serving cell is 2, an RRC parameter Number-MCS-HARQ-DL-DCI=2, N_{HARQ-ACK,0}^{CBG/PDSCH,max}=4, and SPS is activated. A secondary serving cell has an ID of 1 and an RRC parameter CBG-DL=ON. An RRC parameter CBGs-per-TB-DL configures that the maximum number N_{HARQ-ACK}^{CBG/TB,max} of CBGs included in the TB of the secondary serving cell is 6, an RRC parameter Number-MCS-HARQ-DL-DCI=1, N_{HARQ-ACK,c}^{CBG/TB,max}=6, and N_{HARQ-ACK,0}^{CBG/PDSCH,max}=6.

By above embodiments, when the UE receives one PDSCH scheduled by a PDCCH or an SPS deactivation indicated by a PDCCH, the UE uses N_{HARQ-ACK,max}^{CBG/PDSCH,max}=6 HARQ-ACK bits to feed back a CBG-level HARQ-ACK.

Specifically, in a slot T81, to the serving cell 0, if an SPS deactivation indicated by a PDCCH is received, and feedback time K1=4, the generated codebook is 100000; to the serving cell 1, if a PDSCH scheduled with a format of DCI format 1_0 is received and the TB is decoded correctly, and feedback time K1=4, the generated codebook is 100000.

In a slot T82, to the serving cell 0, if a PDSCH scheduled with a format of DCI format 1_1 is received and two TBs are decoded correctly, and feedback time K1=2, the generated codebook is 111100.

In a slot T83 corresponding to a HARQ-ACK feedback time point, the total codebook fed back is 100000100000111100.

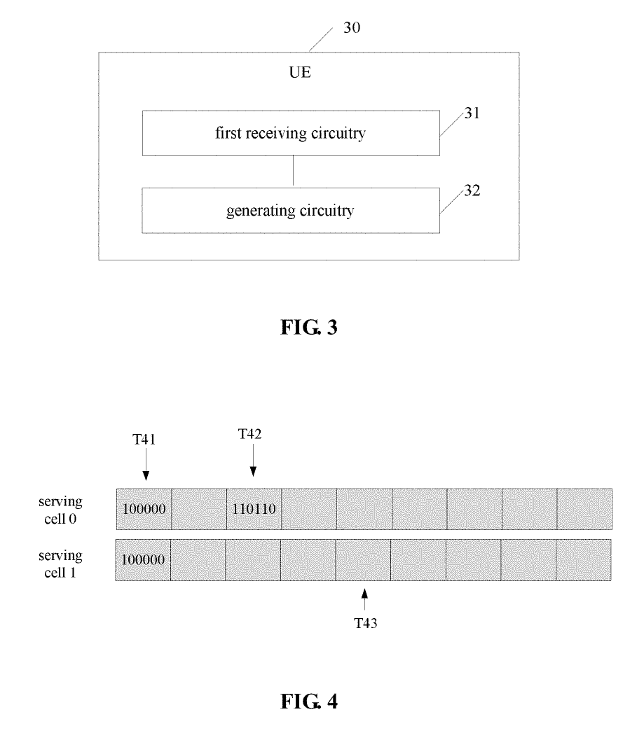

To make those skilled in the art better understand and implement solutions of the present disclosure, embodiments of the present disclosure further provide a UE capable of implementing the above method for generating the HARQ codebook, as shown in FIG. 3.

Referring to FIG. 3, the UE 30 includes a first receiving circuitry 31 and a generating circuitry 32.

The first receiving circuitry 31 is configured to receive PDSCHs each of which includes at least one TB.

The generating circuitry 32 is configured to: to serving cells which are configured with CBG-based HARQ feedback, generate a HARQ codebook corresponding to the PDSCHs using N bits per PDSCH, where N is a maximum value of numbers of CBGs corresponding to the PDSCHs.

In some embodiments, if the number of the serving cells which are configured with CBG-based HARQ feedback is more than one, and the HARQ codebook is configured as a dynamic HARQ codebook, N is max{Nᵢ}, where i is an identifier of the serving cell which are configured with CBG-based HARQ feedback, Nᵢ is the maximum value of numbers of CBGs corresponding to the PDSCHs for the corresponding serving cell i, and max{} represents taking the maximum value.

In some embodiments, the UE 30 further includes a second receiving circuitry (not shown) configured to receive a signaling from a base station, where the signaling includes the number of TBs in each of the PDSCHs in the serving cell i, for example, Number-MCS-HARQ-DL-DCI. If the number of TBs in each of the PDSCHs in the serving cell i is two, Nᵢ=2×Nᵢ^{TB}; and if the number of TBs in each of the PDSCHs in the serving cell i is one, Nᵢ=Nᵢ^{TB}, where i is an identifier of one of the serving cells which are configured with CBG-based HARQ feedback, and Nᵢ^{TB} is a maximum value of numbers of CBGs corresponding to the TBs for the corresponding serving cell i.

In some embodiments, if a DCI format corresponding to the PDSCHs is DCI format 1_1, the generating circuitry 32 is configured to: if the number of TBs in each of the PDSCHs is two, generate a first HARQ codebook corresponding to CBGs included in the first TB using first N/2 bits; and generate a second HARQ codebook corresponding to CBGs included in the second TB using remaining N/2 bits.

In some embodiments, the generating circuitry 32 is configured to: if M1 is less than N/2, generate the first HARQ codebook corresponding to CBGs included in the first TB using first M1 bits among the first N/2 bits; and set remaining (N/2−M1) bits to NACK, where M1 is the maximum value of the number of CBGs corresponding to the first TB.

In some embodiments, the generating circuitry 32 is configured to: if M2 is less than N/2, generate the second HARQ codebook corresponding to CBGs included in the second TB using first M2 bits among the remaining N/2 bits; and set remaining (N/2−M2) bits to NACK, where M2 is the maximum value of the number of CBGs corresponding to the second TB.

In some embodiments, if the DCI format corresponding to the PDSCHs is DCI format 1_1, the generating circuitry 32 is configured to: if the number of TBs in each of the PDSCHs is two and M1+M2<N, generate a first HARQ codebook corresponding to CBGs included in the first TB using first M1 bits; generate a second HARQ codebook corresponding to CBGs included in the second TB using M2 bits following the first M1 bits; and set remaining (N−M1−M2) bits to NACK, where M1 is the maximum value of the number of CBGs corresponding to the first TB, and M2 is the maximum value of the number of CBGs corresponding to the second TB.

In some embodiments, if the DCI format corresponding to the PDSCHs is DCI format 1_1, the generating circuitry 32 is configured to: if the number of TBs in each of the PDSCHs is one and M0<N, generate the HARQ codebook corresponding to CBGs included in the TB using first M0 bits; and set remaining (N−M0) bits to NACK, where M0 is the maximum value of the number of CBGs corresponding to the TB.

In some embodiments, if the DCI format corresponding to the PDSCHs is DCI format 1_0, the generating circuitry 32 is configured to: generate the HARQ codebook corresponding to the TB using a first bit; and set remaining (N−1) bits to NACK.

Operation procedures and principles of the UE 30 can be referred to the descriptions of the method for generating the HARQ codebook provided in the above embodiments, and are not described in detail here.

In an embodiment of the present disclosure, a computer readable storage medium having computer instructions stored therein is provided, where once the computer instructions are executed, any one of the above methods for generating the HARQ codebook is performed. The computer readable storage medium is a non-volatile or non-transient storage medium.

In an embodiment of the present disclosure, a UE including a memory and a processor is provided, where the memory has computer instructions stored therein, and once the processor executes the computer instructions, any one of the above methods for generating the HARQ codebook is performed.

Those skilled in the art can understand that all of or a portion of the processes in the method provided in the above embodiments can be implemented by related hardware with instruction of computer program. The computer program may be stored in a readable storage medium, such as a magnetic disk, an optical disk, a Read-Only Memory (ROM) or a Random Access Memory (RAM).

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for generating a Hybrid Automatic Repeat reQuest (HARQ) codebook, comprising:
receiving Physical Downlink Shared Channels (PDSCHs) each of which comprises at least one Transport Block (TB); and
to serving cells which are configured with Code Block Group (CBG)-based HARQ feedback, generating a HARQ codebook corresponding to the PDSCHs using N bits per PDSCH, wherein N is a maximum value of numbers of CBGs corresponding to the PDSCHs.

2. The method according to claim 1, wherein if the number of the serving cells which are configured with CBG-based HARQ feedback is more than one, and the HARQ codebook is configured as a dynamic HARQ codebook, N is max {Nᵢ}, where i is an identifier of one of the serving cells which are configured with CBG-based HARQ feedback, Nᵢ is the maximum value of numbers of CBGs corresponding to the PDSCHs for the corresponding serving cell i, and max{} represents taking the maximum value.

3. The method according to claim 2, further comprising: receiving a signaling from a base station,
wherein the signaling comprises the number of TBs in each of the PDSCHs in the serving cell i; if the number of TBs in each of the PDSCHs in the serving cell i is two, Nᵢ=2×Nᵢ^{TB}; and if the number of TBs in each of the PDSCHs in the serving cell i is one, Nᵢ=Nᵢ^{TB}, where i is an identifier of one of the serving cells which are configured with CBG-based HARQ feedback, and Nᵢ^{TB} is a maximum value of numbers of CBGs corresponding to the TBs for the corresponding serving cell i.

4. The method according to claim 3, wherein if a Downlink Control Information (DCI) format corresponding to the PDSCHs is DCI format 1_1, generating the HARQ codebook corresponding to the PDSCHs using N bits per PDSCH comprises:
if the number of TBs in each of the PDSCHs is two, generating a first HARQ codebook corresponding to CBGs included in a first TB using first N/2 bits; and
generating a second HARQ codebook corresponding to CBGs included in a second TB using remaining N/2 bits.

5. The method according to claim 4, wherein generating the first HARQ codebook corresponding to CBGs included in the first TB using the first N/2 bits comprises:
if M1 is less than N/2, generating the first HARQ codebook corresponding to CBGs included in the first TB using first M1 bits among the first N/2 bits; and setting remaining (N/2−M1) bits to NACK, where M1 is the maximum value of the number of CBGs corresponding to the first TB.

6. The method according to claim 4, wherein generating the second HARQ codebook corresponding to CBGs included in the second TB using the remaining N/2 bits comprises:
if M2 is less than N/2, generating the second HARQ codebook corresponding to CBGs included in the second TB using first M2 bits among the remaining N/2 bits; and setting remaining (N/2−M2) bits to NACK, where M2 is the maximum value of the number of CBGs corresponding to the second TB.

7. The method according to claim 3, wherein if a DCI format corresponding to the PDSCHs is DCI format 1_1, generating the HARQ codebook corresponding to the PDSCHs using N bits per PDSCH comprises:
if the number of TBs in each of the PDSCHs is two and M1+M2<N, generating a first HARQ codebook corresponding to CBGs included in a first TB using first M1 bits; generating a second HARQ codebook corresponding to CBGs included in a second TB using M2 bits following the first M1 bits; and setting remaining (N−M1−M2) bits to NACK, where M1 is the maximum value of the number of CBGs corresponding to the first TB, and M2 is the maximum value of the number of CBGs corresponding to the second TB.

8. The method according to claim 3, wherein if a DCI format corresponding to the PDSCHs is DCI format 1_1, generating the HARQ codebook corresponding to the PDSCHs using N bits per PDSCH comprises:
if the number of TBs in each of the PDSCHs is one and M0<N, generating the HARQ codebook corresponding to CBGs included in the TB using first M0 bits; and setting remaining (N−M0) bits to NACK, where M0 is the maximum value of the number of CBGs corresponding to the TB.

9. The method according to claim 3, wherein if a DCI format corresponding to the PDSCHs is DCI format 1_0, generating the HARQ codebook corresponding to the PDSCHs using N bits per PDSCH comprises:
generating the HARQ codebook corresponding to the TB using a first bit; and setting remaining (N−1) bits to NACK.

10. A User Equipment (UE), comprising:
a first receiving circuitry, configured to receive Physical Downlink Shared Channels (PDSCHs) each of which comprises at least one Transport Block (TB); and
a generating circuitry, configured to: to serving cells which are configured with Code Block Group (CBG)-based Hybrid Automatic Repeat reQuest (HARQ) feedback, generate a HARQ codebook corresponding to the PDSCHs using N bits per PDSCH, where N is a maximum value of numbers of CBGs corresponding to the PDSCHs.

11. The UE according to claim 10, wherein if the number of the serving cells which are configured with CBG-based HARQ feedback is more than one, and the HARQ codebook is configured as a dynamic HARQ codebook, N is max {Nᵢ}, where i is an identifier of one of the serving cells which are configured with CBG-based HARQ feedback, Nᵢ is the maximum value of numbers of CBGs corresponding to the PDSCHs for the corresponding serving cell i, and max{} represents taking the maximum value.

12. The UE according to claim 11, further comprising:
a second receiving circuitry configured to receive a signaling from a base station,
where the signaling comprises the number of TBs in each of the PDSCHs in the serving cell i; if the number of TBs in each of the PDSCHs in the serving cell i is two, Nᵢ=2×Nᵢ^{TB}; and if the number of TBs in each of the PDSCHs in the serving cell i is one, Nᵢ=Nᵢ^{TB}, where i is an identifier of one of the serving cells which are configured with CBG-based HARQ, and Nᵢ^{TB} is a maximum value of numbers of CBGs corresponding to the TBs for the corresponding serving cell i.

13. The UE according to claim 12, wherein if a DCI format corresponding to the PDSCHs is DCI format 1_1, the generating circuitry is configured to: if the number of TBs in each of the PDSCHs is two, generate a first HARQ codebook corresponding to CBGs included in a first TB using first N/2 bits; and generate a second HARQ codebook corresponding to CBGs included in a second TB using remaining N/2 bits.

14. The UE according to claim 13, wherein the generating circuitry is configured to: if M1 is less than N/2, generate the first HARQ codebook corresponding to CBGs included in the first TB using first M1 bits among the first N/2 bits; and set remaining (N/2−M1) bits to NACK, where M1 is the maximum value of the number of CBGs corresponding to the first TB.

15. The UE according to claim 13, wherein the generating circuitry is configured to: if M2 is less than N/2, generate the second HARQ codebook corresponding to CBGs included in the second TB using first M2 bits among the remaining N/2 bits; and set remaining (N/2−M2) bits to NACK, where M2 is the maximum value of the number of CBGs corresponding to the second TB.

16. The UE according to claim 12, wherein if a DCI format corresponding to the PDSCHs is DCI format 1_1, the generating circuitry is configured to:
if the number of TBs in each of the PDSCHs is two and M1+M2<N, generate a first HARQ codebook corresponding to CBGs included in a first TB using first M1 bits; generate a second HARQ codebook corresponding to CBGs included in a second TB using M2 bits following the first M1 bits; and set remaining (N−M1−M2) bits to NACK, where M1 is the maximum value of the number of CBGs corresponding to the first TB, and M2 is the maximum value of the number of CBGs corresponding to the second TB.

17. The UE according to claim 12, wherein if a DCI format corresponding to the PDSCHs is DCI format 1_1, the generating circuitry is configured to:
if the number of TBs in each of the PDSCHs is one and M0<N, generate the HARQ codebook corresponding to CBGs included in the TB using first M0 bits; and
set remaining (N−M0) bits to NACK, where M0 is the maximum value of the number of CBGs corresponding to the TB.

18. The UE according to claim 12, wherein if a DCI format corresponding to the PDSCHs is DCI format 1_0, the generating circuitry is configured to:
generate the HARQ codebook corresponding to the TBs using a first bit; and set remaining (N−1) bits to NACK.

19. A computer readable storage medium having computer instructions stored therein, wherein once the computer instructions are executed, the method according to claim 1 is performed.

20. A User Equipment (UE) comprising a memory and a processor, wherein the memory has computer instructions stored therein, and once the processor executes the computer instructions, the method according to claim 1 is performed.
